(19) United States
(12) Patent Application Publication
(10) Pub. No.: US 2012/0024102 A1
(43) Pub. Date: Feb. 2, 2012

(54) ARTICULATION DEVICE FOR THE STEERING COLUMN OF A CYCLE

(75) Inventor: Fabrice Marion, Paris (FR)

(73) Assignee: XOR.MOTORS, MEYREUIL (FR)

(21) Appl. No.: 13/141,891

(22) PCT Filed: Dec. 11, 2009
(86) PCT No.: PCT/FR2009/052496

§ 371 Date: Oct. 7, 2011

(30) Foreign Application Priority Data
Dec. 23, 2008 (FR) 08 59030

(51) Int. Cl. B62K 21/22

(52) U.S. Cl. 74/493

(57) ABSTRACT

The invention relates to an articulation device of a so-called steering column of a cycle, the said steering column consisting of at least one fork pivot and one handlebar tube, this steering column comprising two parts, a first part known as the upper part supporting the handlebar of a cycle and a second part known as the lower part supporting at least one front wheel. According to the invention, the said articulation device allows the steering column to be folded back along the chassis of the cycle at the same time as the front wheel is folded along the side of the cycle and allows the articulation to be locked so as to prevent both types of rotation.

### BACKGROUND OF THE INVENTION

The present invention relates to the general field of articulation devices for the articulation of a steering column in two parts, a first part known as the top part supporting the handlebar of a cycle and a second part known as the bottom part supporting at least one front wheel.

More specifically, the invention relates to the devices that can be installed on motorized two-wheeled vehicles. The articulation device according to the invention may notably be fitted to a two-wheeled vehicle fitted with an electric motor.

Various articulation devices that allow part of the steering column to be folded over onto the rear of the cycle exist. In the main, these devices are used on and designed for bicycles, very rarely for lightweight motor vehicles. They involve folding the handlebar over either flat against the frame of the vehicle or at an angle to the side. By folding the handlebar over at an angle to the side, the wheel is allowed to pivot so that both the height and the overall length of the folded vehicle can be decreased.

These devices operate on a principle of dividing the steering column into two parts. The two parts are fixed together by a hinge which allows them, while remaining connected, to be articulated one with respect to the other. These devices are supplemented by one or more locking elements that firmly lock the articulation in the closed position when the handlebar is unfolded, the two parts of the steering column then being detached in the vertical plane.

These devices are designed for lightweight vehicles that travel at a limited speed. They concentrate on ease of handling and compactness. Their limits lie in the insufficient rigidity over time of the connection between the two parts and in the fact that they are not suited to the volume occupied by a front fairing of the vehicle such as a motor scooter.

The problem is that the rigidity of the connection between the tubes tends to deteriorate over time, taking on a degree of play that is detrimental to driving precision. The stresses on the locking element are indeed high, because of the important lever effect caused by the miniaturizing of the locking element which is generally situated beyond the pivot, in relation to the long lever consisting of the top part of the steering column that the driver pushes and pulls turn and turn about, sometimes hard, depending on the layout of the route and the type of driving style.

In a motor vehicle, the stresses are even higher, because the mass and speed are also higher.

Another disadvantage with the existing devices is that they are ill-suited to a vehicle that has a fairing. This is because folding over flat onto the vehicle keeps the wheel along the longitudinal axis and does not allow it to pivot to reduce the folded length, and folding over at an angle positions the fairing on the edge and increases the folded height, which runs counter to the objective of the compactness of the folding.

### SUBJECT AND SUMMARY OF THE INVENTION

One main aim of the present invention is therefore to reconcile these differences in order to achieve the most compact possible folding both in terms of height and in terms of length while at the same time maintaining a maximum overall length once the vehicle has been unfolded, and to alleviate the abovementioned disadvantages by proposing an articulation device for articulating a so-called steering column of a cycle comprising a chassis, said steering column being made up of at least one fork column and a handlebar tube, this steering column comprising two parts, a first part known as the top part supporting the handlebar of the cycle and a second part known as the bottom part supporting at least one front wheel, the articulation device allowing the steering column to be folded and being intended to be positioned above the head tube of the cycle, characterized in that said articulation device which can be installed on a cycle that has a fairing, allows the steering column to be folded along the chassis of the cycle, the two parts of the steering column being articulated to one another to rotate about an axis perpendicular to the direction of the head tube and to rotate about an axis parallel to the head tube, so as to allow the bottom part of the steering column to be folded over about the axis parallel to the head tube at the same time as the top part is being folded along the chassis of the cycle, and in that the articulation device further comprises locking elements that lock the articulation to prevent both types of rotation.

The invention allows the handlebar and its fairing to be folded over flat onto the chassis or frame of the vehicle, while at the same time allowing the wheel to be pivoted as it is now offset from the handlebar.

By allowing the wheel to pivot, the space taken up by this wheel in the longitudinal plane can be reduced because the span of the wheel is smaller than its diameter.

The use of a front/rear pivot for pivoting about a horizontal axis, associated with a left/right pivot via a vertical axis, allows the handlebar to pivot flat with respect to the forks and allows the forks to pivot with respect to the handlebar that has been folded flat.

The invention is particularly suited to folding two-wheeled vehicles of the motor scooter or moped type. Such vehicles are generally fitted with the most compact possible drive means which are the most compatible with folding operations. In this particular instance, such a vehicle is advantageously fitted with an electric motor installed in the hub of the wheel and powered by batteries.

The invention makes it possible, while enjoying the benefit of a true motor scooter, to make its general use easier, particularly in an urban context, by making it easier to store, secure and transport. In particular, the ability to easily store the vehicle inside a lodging, apartment or house makes it possible to avoid theft, damage and inclement weather.

The invention also makes it easier for the vehicle to be taken around, notably in the luggage compartment of a car, a bus or even a “cycle” or luggage space on a train, to extend these modes of transport toward the destination. Use in combination with public transport is particularly suited to an environmentally friendly mode of travel. This allows uses on top of those of conventional two-wheeled motor vehicles. On the whole, the ability to take it around and store it means it can be used on more numerous occasions.

The benefit of being able to pivot the handlebar, prior to or at the same time as pivoting the forks and the front wheel, addresses the problem of size due to the fact that the handlebar is, on motorized vehicles, fitted with a fairing that is wide in comparison with its thickness.

It will be readily understood firstly that the space taken up by the handlebar is considerably smaller when the fairing is folded flat along the axis of the cycle as is made possible when the handlebar is pivoted along the axis of the vehicle. It will be understood secondly that pivoting the front wheel makes it possible to reduce the space taken up by the cycle. Hence, if there is a wish to pivot the wheel and to fold the handlebar over onto the rear of the cycle, the handlebar fairing constitutes a lateral bulk that prevents the handlebar from pivoting.

The invention makes it possible to pivot the wheel at the same time as folding the handlebar over backward without the handlebar fairing getting in the way.

With the invention, the space saved in the longitudinal plane for the space taken up by the wheel is advantageously used to increase the length of the chassis while at the same time remaining within a predetermined folded overall length.

According to a first embodiment of the invention, once the locking elements have been deactivated, the rotational articulations are such that the bottom part of the steering column is free to rotate in the head tube.

This embodiment allows the user to pivot the front wheel perpendicular to the longitudinal axis of the cycle so as to reduce the parallelepipedal volume within which the folded cycle can be inscribed.

According to a preferred embodiment of the invention, once the locking elements have been deactivated, the rotational articulations are such that the bottom part of the steering column is forced to rotate over a portion of predetermined angle when the top part of the steering column pivots about the axis perpendicular to the steering column.

This embodiment allows the front wheel to rotate automatically through a predetermined angle advantageously 90°, as the handlebar carried by the top part of the steering column is folded over onto the chassis of the vehicle. No intervention other than the folding of the handlebar over against the chassis of the cycle is required of the user. The angular travel of folding of the steering column is thus used directly in order to cause the bottom part of the steering column to turn.

According to a preferred implementation, with the articulation device being intended to be installed on the handlebar tube, it comprises two plates articulated about a pivot pin perpendicular to the steering column, an upper plate being secured to the top part, the lower plate being such that the bottom part of the steering column is mounted to rotate with respect to this lower plate, the locking elements being capable of keeping the plates folded over on one another, thus preventing the top part from rotating about an axis perpendicular to the steering column and also preventing the bottom part from rotating about the axis parallel to the steering column.

This preferred embodiment makes it possible to maintain the compactness of the existing devices which are based on the use of two plates acting like jaws. The fact that the bottom part is mounted to rotate in the lower plate allows for a compact implementation of the invention. It must be pointed out here that the steering column and head tube have parallel and substantially identical directresses.

Advantageously, the locking elements comprise a hook pivoting about a horizontal pivot pin perpendicular to the steering column, fixed to the lower plate, and of which a hooked part slides along the upper external surface of the upper plate when the two plates are butted against one another when the steering column is unfolded.

One alternative form is that the locking elements comprise a U-shaped lock the two branches of which slide along the external surfaces of the two plates butted against one another when the steering column is unfolded.

Such a lock or such a hook allows the two parts to be kept in position in terms of rotation about a horizontal axis.

Advantageously, the sliding/rotating movement of the hooked part is brought about by a lever associated with a cam.

According to one particular feature of the invention, the bottom part of said steering column comprises a rotary swivel passing through the lower plate in which it is mounted such that it can rotate.

This feature allows the rotary swivel secured to the bottom part of the steering column to be accessed from the top side of the lower plate.

Thus, advantageously, the locking elements comprise, on the rotary swivel and on the underside of the top plate, complementary reliefs that interlock when the two plates are folded over against one another.

Thus the relative rotational movements of the upper plate and of the rotary swivel is prevented as soon as the two plates are brought closer together. The possibility of accessing the rotary swivel from the top surface of the lower plate means that such locking elements that are particularly easy to produce can be used. This feature is a particularly simple and effective way of preventing the relative rotational movements of the rotary swivel with respect to the upper plate as soon as the latter is brought against the lower plate.

According to one advantageous embodiment, the rotary swivel comprises at least one traction point that can be connected by a link rod to a traction point on the upper plate, this traction point driving the rotary swivel in rotation as soon as the plates become separated from one another during the folding of the top part of the steering column onto the chassis of the cycle.

The link rod or any other mechanical element capable of traction and which therefore has the function of connecting the two traction points, driven by the angular travel, pulls on the rotary swivel and thus causes this swivel to turn. This embodiment is robust and offers ease of maintenance because it is easy to replace the link rod should it break. In any event, such breakage frees the bottom part of the steering column so that it can rotate, and this is not detrimental to the overall operation of the articulation device except for the fact that the rotational movement will then have to be performed manually by the user because the front wheel will then be free to rotate rather than held in its position folded over at 90°. However, when the articulation device is closed and locked, the articulation device will not offer the freedom to rotate and the cycle will be useable.

Advantageously, the link rod is fixed with play on a pintle that has a retaining head positioned perpendicular to the upper surface of the rotary swivel and clamps a shank of axis parallel to the axis of rotation of the two plates.

This installation of the link rod is particularly well suited to the stresses of the device as it does not introduce any torsional loadings into the articulations between the various parts that articulate the top bearer and the lower bearer. The link rod can thus be made of a rigid material and mounted with enough play to allow it to adopt the positions it needs for the invention to work. It may also be made of a flexible inelastic material.

In an alternative form, the upper plate carries gear structures that complement gear structures carried by the rotary swivel meshing at 90° to one another and driving the rotary swivel in rotation as soon as the plates are separated from one another as the top part of the steering column is folded onto the chassis of the cycle.

Advantageously, the gear structures are at 45° to the surfaces of the rotating disks so that they mesh in two perpendicular planes allowing rotations about the two perpendicular axes.

This implementation is very rigid and systematically causes the wheel to turn in a way that is closely connected with the movement of folding the handlebar over onto the chassis. Nonetheless, in the event of damage to the gears or in the event of obstacles impeding the pivoting of the wheel, this implementation prevents the handlebar from being folded over toward the chassis, and this could be detrimental.

In one particularly advantageous embodiment, the top part of the steering column is made up of two symmetrical lateral tubes each connected to half a handlebar, these lateral tubes being mounted to rotate with respect to the upper plate about axes that are substantially parallel to the steering column so that the half-handlebars can be folded over toward one another as the steering column is folded, the rotations of the two lateral tubes being impeded when the locking elements are activated.

This embodiment allows the folding over of the handlebar, the folding over of the front wheel and the folding of the handlebar grips to be locked/unlocked in a single action using a single component.

Advantageously, the hooked part of the hook has a shape that allows it to impede the rotational movement of the two lateral tubes which have shapes that complement the shape of the hooked part.

In one embodiment, the lateral tubes each comprise a washer disk the shape of which cooperates with the shape of the hooked part to prevent the rotation of the lateral tubes, it being possible for the complementary shapes to be chosen from two flat surfaces or a stud with complementary housing.

Typically, when a washer is positioned at the bottom of the lateral handlebar tubes, this washer can be modified so that a flat surface appears at its periphery, this flat surface then coming to press against another flat surface borne by the hook.

According to an additional feature of the invention, when the complementary shapes are a stud collaborating with a complementary housing, the studs are mounted on a component that is itself attached to the hook by screws that allow its separation from the hook to be adjusted, thus fine-tuning the extent to which the studs penetrate the housings in the bottom of the handlebar tubes.

This feature has a number of alternative forms, it being possible in particular for the studs to be used at the bottom of the lateral tubes, for example in the region of washers, or on the tubes themselves. The complementary housings will then be borne by the piece that moves in the hook.

According to another embodiment, the device comprises two bearers known as the top bearer and the bottom bearer, the top part supporting the handlebar tube and the bottom part supporting the fork column, and a part known as an intermediate part mounted to rotate about an axis perpendicular to the direction of the head tube with respect to one of the bearers, thus allowing this bearer to rotate about an axis perpendicular to the direction of the head tube and to rotate about an axis parallel to the head tube with respect to the other bearer and thus allowing the other bearer to rotate about an axis parallel to the steering column.

With such a feature, a compact so-called intermediate single component is used both as the horizontal pivot pin about which the top bearer rotates and as a sliding component that permits rotation about a substantially vertical axis.

According to one implementation, the bottom part of the steering column has a complex structure made up of a fork column which is offset toward the rear of the cycle with respect to the handlebar tube and can be housed in the head tube secured to the chassis of the cycle and two lateral arms extending the forks and between which the handlebar tube is positioned, these two lateral arms being positioned between two plates that also hold the offset fork column.

According to this embodiment, by duplicating the steering column/fork column structure in the form of two distinct mechanical elements, the articulation device which is no longer limited to a short length of said steering column enjoys greater robustness. In particular, the height of the articulation device itself, which is also generally the height of the head tube, may represent 10 to 30% of the total height of the steering column. This height stiffens the steering. This therefore improves the reliability of the articulation device by increasing its ability to withstand high stresses. A notch accepting the handlebar tube may possibly be provided on the bearer, limiting risks of torsion.

Thus advantageously the top plate of the bottom bearer has an arc-shaped notch, for example a semicircular notch, in which the handlebar tube is wedged.

Also advantageously, the bottom plate bearing the offset steering column may act as a cross-member between the two branches of the fork forward of the head tube and of the fork column. The bottom plate also advantageously comprises a locking element for locking the bottom of the top part of said steering column, which element lies between the lateral arms.

In one particular implementation, the intermediate component comprises a shank positioned perpendicular to the direction of the head tube and around which the top bearer is mounted to rotate, this shank bearing, at its ends, structures that are capable of pivoting or sliding in complementary structures borne by the bottom bearer during a rotational movement of the intermediate component with respect to the top bearer about an axis parallel to the direction of the head tube.

The intermediate component therefore centralizes the mechanical elements that allow the two rotations. It is thus possible to centralize onto this component the stresses that are experienced. As a result, advantageously, only this component will need to be replaced in the event of a malfunction.

According to one embodiment, the structures borne by the intermediate shank are, respectively, a lug of axis parallel to the shank and a lug of axis perpendicular to the shank to slide respectively in a translational movement in an arc-shaped slideway borne by the bottom bearer and in a rotational movement in an orifice made in the bottom bearer.

This embodiment is particularly simple to manufacture, and this is of benefit in terms of the robustness and performance of the articulation device.

According to one advantageous feature, the locking elements comprise a lug able to slide along the handlebar tube and become housed in an orifice provided for this purpose in the bottom bearer.

This feature allows locking in position that is simple to perform simply by sliding a component within the handlebar tube.

For preference, the sliding movement of the lug is commanded by a hand lever associated with a link rod.

Such a hand lever, preferably positioned at a mid level of the fork column so that it is accessible to the user, allows for particularly easy and ergonomic locking and unlocking.

According to an additional and independent feature of the implementation of the invention, the folding over of the handlebar grips completes the device according to the invention by reducing the width of the folded vehicle.

The handlebar grips bear accessories that fall within a volume and lie on an axis close to the handlebar grip itself (brakes, throttle, switches, etc.). On a motor vehicle, they also support rear-view mirrors that are relatively bulky and protruding in accordance with the standards.

There are various systems that exist and involve either dislocating and relocating or articulating the handlebar grips with respect to the handlebar either in the vertical plane or in the horizontal plane. The known systems do not cover the folding over of the rear-view mirrors of the vehicle, and still less do they cover systems in which all of the folding-over operations are performed in a single action.

For preference, the angle between the vertical and the axes of rotation of the half-handlebars is between 30 and 40° and preferably around 33°. These angles allow the rear-view mirrors to be folded over in such a way that they can be inscribed inside the volume of the folded vehicle.

Hence, advantageously, the top part of the steering column bears a folding handlebar comprising two lateral half-handlebar tubes bearing handlebar grips which tubes are mounted to rotate about two pivot pins at the two ends of a central casing comprising notches to allow this rotation of the lateral tubes and a retaining element for holding the half-handlebars in position, the two pivot pins about which the two lateral half-handlebars are mounted to rotate make an angle of between 10° and 40° downward and toward the rear of the cycle, with respect to the vertical.

The present system allows the handlebar grips, including the rear-view mirrors, to be folded over easily inside the volume of the folded vehicle, in a single operation. The handlebar grips are in fact mounted on pivot pins that allow them to pivot, fixed to a casing or a plate, which is itself fixed to the top part of said steering column.

According to one advantageous feature, the casing comprises a double pawl positioned at the center of this casing and mounted for partial rotation with a return spring, about a shank perpendicular to the longitudinal direction of the casing, the pawl having a surface known as the rear surface that is such that, depending on the angle made by the pawl with respect to the longitudinal direction of the casing, it either allows or does not allow the tubes to pass, and a front surface of beveled shape the bevel being symmetric with respect to the pivot pin, so that the tubes come against the beveled surfaces as the handlebar is unfolded, causing partial rotation of the pawl, this rotation freeing the movement of the tubes which position themselves behind the pawl, this pawl then, thanks to the return spring, repositioning itself in front of the tubes thereby preventing their rotational movement by contact of the tubes on its rear surface, the pawl being connected to an unlock knob mounted on the pivot pin of the pawl and allowing the rotational movement of the tubes to be freed through the turning of this knob.

The use of such a pawl offers the possibility of engaging and holding the half-handlebars in position automatically with no additional intervention on the part of the user other than to bring the half-handlebars into the expected and conventional position occupied by a handlebar.

### BRIEF DESCRIPTION OF THE DRAWINGS

Other features and advantages of the present invention will emerge from the description given hereinbelow with reference to the attached drawings which illustrate one entirely non-limiting embodiment thereof. In the figures:

FIG. 1 is a side view of a cycle with a folding and folded handlebar comprising a fork column equipped with a device according to a first embodiment of the invention;

FIG. 2 is a perspective view of the first embodiment of a device according to the invention in a first position in a locked situation;

FIG. 3 is another perspective view of the first embodiment of a device according to the invention in a first position in a locked situation;

FIG. 4 is a perspective view of the first embodiment of a device according to the invention in the first position in an unlocked situation;

FIG. 5 is a perspective view of the first embodiment of a device according to the invention in a second position in which the handlebar and the front wheel are folded over;

FIG. 6 is a side view of a cycle with a folding and folded handlebar comprising a fork column fitted with a device according to a second embodiment of the invention;

FIG. 7 is a perspective view of a preferred second embodiment of a device according to the invention in a locked situation;

FIG. 8 is an angled front view of the preferred embodiment of a device according to the invention in an unlocked and open situation;

FIGS. 9A and 9B are side views of the preferred embodiment of a device according to the invention in a locked situation and closed position and in an unlocked situation and open position, respectively;

FIG. 10 is a perspective view of the preferred embodiment of a device according to the invention in an unlocked situation and open position;

FIGS. 11A and 11B depict, in a closed position and locked situation, as a perspective view and a side view respectively, an alternative form of embodiment of the second embodiment in which the fork is forced to rotate by the folding of the steering column;

FIG. 12 is a perspective depiction, in a closed position and unlocked situation, of the alternative form of embodiment of FIG. 11;

FIGS. 13A, 13B and 13C depict, in an open position, and unlocked, the alternative form of embodiment of FIG. 11 in perspective, in a side view, and in a view from above, respectively;

FIG. 14 is an open view from above of a handlebar folded according to a preferred embodiment of the invention;

FIG. 15 is an open view from above of a handlebar according to the preferred embodiment of the invention as it is being unfolded;

FIG. 16 shows the functional components of the handlebar depicted in FIGS. 14 and 15;

FIG. 17 is an open view from above of the handlebar depicted in FIGS. 14 and 15 at the start of folding;

FIGS. 18A and 18B are perspective depictions of one preferred embodiment of an articulation device according to the invention, in the closed and locked position and in the open and unlocked position, respectively;

FIGS. 19A, 19B and 19C show a preferred embodiment for a bolt that can be used in the preferred embodiment of the device according to the invention shown in FIGS. 18A and 18B.

### DETAILED DESCRIPTION OF ONE EMBODIMENT

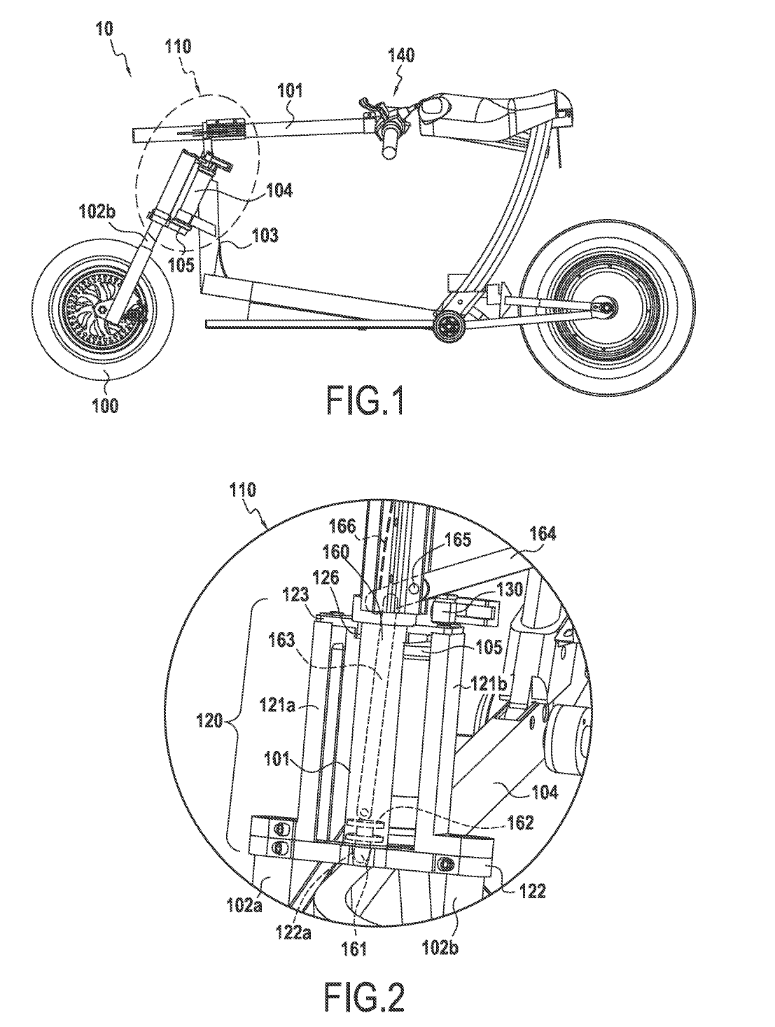

FIG. 1 depicts a cycle 10 comprising a steering column, this steering column including a fork column and a handlebar tube. Said steering column is in two parts, a part known as the top part 101 and a part known as the bottom part 102. The part 101 supports a handlebar 140 and the bottom part 102 supports at least one front wheel 100.

In this embodiment, it so happens that the top part 101 consists mainly of the handlebar tube. The two parts 101 and 102 are articulated using an articulation device 110 according to the invention. The cycle 10 comprises a frame or chassis 103 supporting a head tube 104 secured to the chassis 103 of the cycle and in which the fork column 105 pivots.

In the first embodiment of FIG. 1, the articulation device 110 is such that at the same level as the fork column 105 mounted to rotate in the head tube 104 there is part of the articulation device 110. That means that the fork column 105 has to be offset with respect to the handlebar tube denoted 101. This is specific to the embodiment set out in this example. In particular, the locking in the unfolded position is situated at the level of the fork column 105 in this embodiment.

The bottom part 102 of the steering column is secured to a bottom bearer 120 depicted in FIG. 2. This bottom bearer 120 comprises a number of functional components. In the embodiment depicted in FIG. 2 it is secured to the bottom part 102, here consisting of the two branches of the fork 102a and 102b, and also carries the fork column 105 fitted with the steering headset. This pivot 105 is capable of pivoting in the head tube 104.

The bottom bearer 120 comprises two lateral arms 121a and 121b between which the top part 101 of the steering column, consisting of the handlebar tube, will be situated. The bottom bearer 120 comprises a first, lower plate 122 resting against the two branches of the fork 102a and 102b and supporting the two lateral arms 121a and 121b and the lower end of the fork column 105.

The bottom bearer 120 comprises another plate 123 resting against the lateral arms 121a and 121b and the top end of the fork column 105.

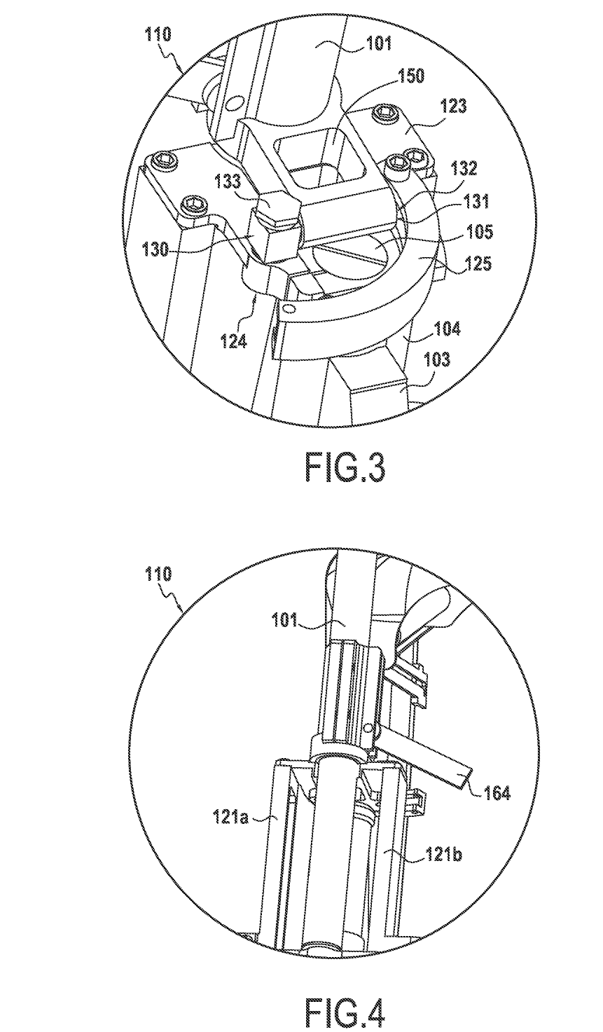

As has been depicted in FIG. 3 in which the bottom bearer 102 is viewed from a different angle, the plate 123 also comprises an orifice 124 and a slideway 125 the purposes of which are to collaborate with an intermediate component referenced 130.

The orifice 124 and the slideway 125 respectively allow the intermediate component 130 to rotate with respect to the lower bearer 120 and allow the lower bearer 120 to rotate with respect to the intermediate component 130.

The intermediate component 130 supports a shank 131 the end of which forms a first lug 132 and a second lug 133 perpendicular to the shank 131. The first lug 132 is able to slide in the slideway 125 borne by the plate 123 of the bottom bearer 120. The second lug 133 is able to pivot in the orifice 124 made in the plate 123. Thus the intermediate component 130 is given a degree of freedom in rotation about an axis parallel to the steering column, or substantially parallel thereto.

The top bearer 150, to which the top part 101 of the fork column bearing the handlebar 140 is fixed, is also mounted to rotate about the shank 131. Thus, when the top bearer 150 pivots about the shank 131, the top part 101 is folded over toward the frame 103 of the cycle 10, this being as soon as the wheel 100 is directed in the direction of travel of the cycle 10 when the folding movement is begun. The characteristics of such folding are useful for a cycle with a fairing in which the direction of folding of the steering column is a single direction dictated by the fairing. For obvious compactness reasons, this folding has to be along the axis of the cycle.

As can be seen in FIG. 2, the articulation device 110 is such that it includes locking elements 160. In the embodiment set out in the preceding figures, these locking elements are implemented on the plates 122 and 123 and in the handlebar tube 101.

The plate 122 comprises an orifice 122a intended to accept a lug 161 that slides in an end cap 162 of the top part 101. The lug 161 is borne by an articulated link rod 163 that can be made to effect a translational movement. The lug 161 advantageously in its penetrating part adopts a cylindrical shape over a few millimeters and then a rounded or tapered shape which comes under stress in the orifice 122a. The inserted cylindrical part prevents any unwanted disengagement of the lug 161. The rounded or tapered part stressed in the bottom of the orifice 122a advantageously takes up any play upon contact between the two moving parts.

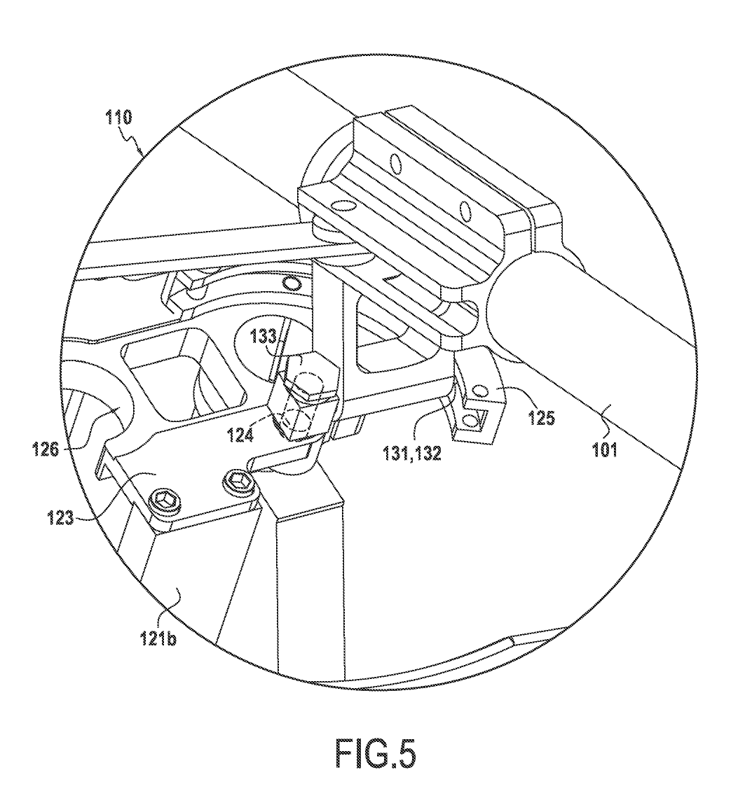

The translation movement of the link rod 163 is brought about using a lever handle 164 mounted to rotate about an eccentric pivot pin 165 or a cam, situated higher up on the handlebar tube 101. FIGS. 4 and 5 show the position of the lever handle 164 when the articulation is being unlocked.

The plate 123 supports a notch 126, visible in FIG. 5, which is able to accept the tubular top part 101.

To make the handling more practical for the user, the lug 161 housed in the bottom of the handlebar tube may be mounted on a spring which pushes it toward the outside of the handlebar tube. The orifice 122a may advantageously be preceded by an inclined shape sloping upward toward the orifice 122a so that the lug 161 slides along this incline until it becomes aligned with the orifice 122a that it can then enter without difficulty.

When the articulation device is unlocked as in FIG. 4, the lug 161 is disengaged from the orifice 122a. In this case, the top bearer 150 is free to rotate toward the rear of the cycle 10.

FIG. 5 shows the device with the top part 101 pivoted to the rear about the shank 131. In this figure, it may also be seen that the bottom bearer 120 carrying the branches of the fork 102a and 102b and the wheel 100 are free to rotate thanks to the pivot permitted by the presence of the lug 133 that can rotate in the orifice 124 and of the lug 132 that can slide in the slideway 125. The notch 126 will be used when unfolding the fork column to center the handlebar tube 101 correctly with respect to the bottom part 102 when the bottom bearer 120 is returned to align the wheel 100 with the longitudinal axis of the cycle 10.

In addition to having a guiding function, the slideway 125 also contributes to the stiffening of the components allowing the rotation of the bottom bearer 120.

It will be noted that rotation of the bottom bearer 120 with respect to the top bearer 150 is free rotation. Nonetheless, it should be pointed out that non-alignment of the fork column 105 with the pivot pin 133 about which the intermediate component 130 pivots with respect to the bottom bearer 120 means that a rearward traction force applied to the folded handlebar tube 101 contributes to driving the bottom bearer 120 and the wheel 100 to the side. The tractive moment is then actually transmitted to the fork via the offset fork column 105.

So, once the handlebar tube 101 has been pivoted into a horizontal position and held along the axis of the vehicle, by pulling the handlebar toward the rear of the vehicle, the entire assembly consisting of the bottom bearer 120 and of the bottom part 102 of the steering column can be pivoted as one. Indeed, such an action allows the top plate 123 to be pulled, and this causes the fork column 105 to pivot in the head tube 104. The wheel 100 is then driven through approximately 90°. The user then has merely to pull the handlebar back in order to bring the wheel to the side once the handlebar tube has been folded, making the cycle easier to handle.

It will be noted that offsetting the pivot of the fork column allows the handlebar tube to be kept in a single piece, the bottom part of the steering column defined according to the invention consisting of the lateral branches of the fork and of the bottom bearer as a whole. As it is not split into two parts joined together by a hinge and a lock, the handlebar tube is rigid and robust. Further, because it may stretch out over a significant height in front of the fork column, locking being performed at its lower end, the lever effect that the handlebar has on the articulation device is reduced by comparison with the use of a hinge of small vertical dimension.

Further, the fact that it is not inserted inside the head tube 104, unlike conventional practice, makes for ease of maintenance and allows any replacement that might be required to be performed more easily.

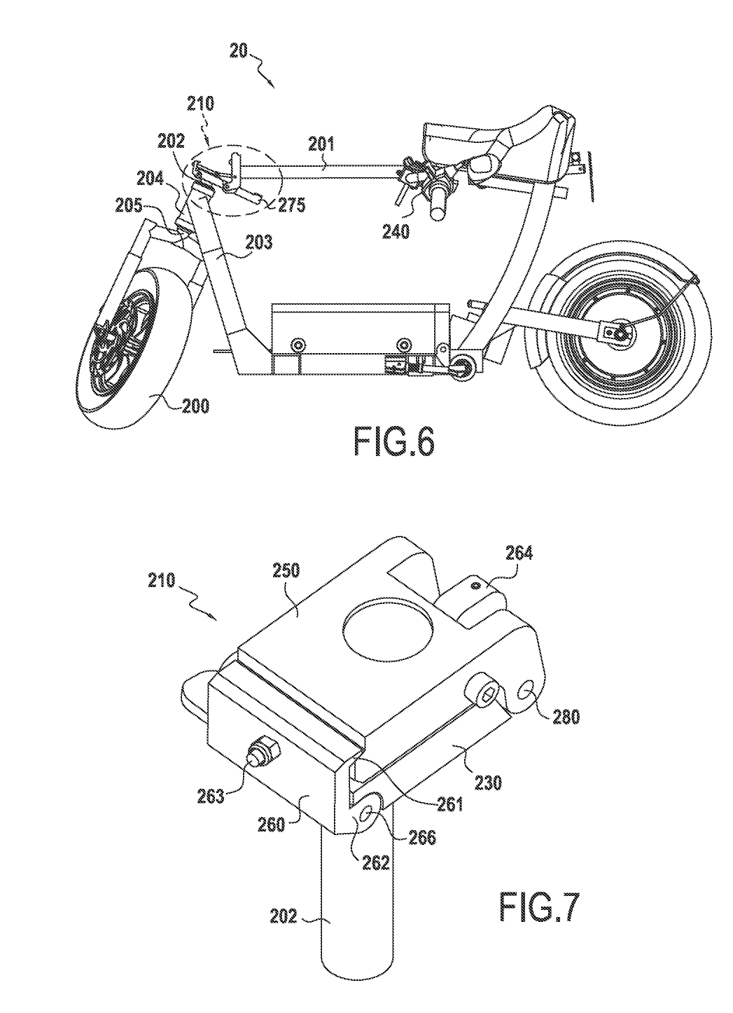

FIG. 6 depicts a second preferred embodiment of an articulation device 210 according to the invention installed on a cycle 20. The cycle 20 comprises a frame 203 supporting a head tube 204 in which a steering column pivots. This steering column overall comprises a fork column 205 and a handlebar tube, here engaged in the fork column in the conventional way, but comprising two articulated parts. Specifically, in the embodiment of FIG. 6, only the handlebar tube is articulated in two parts known as the top part 201 and the bottom part 202 above a head tube 204.

The bottom part 202 is secured to the fork column 205 and inserted deeply therein. The top part 201 supports a handlebar 240 and the bottom part 202 is therefore engaged in the fork column 205 which supports at least one front wheel 200. The two parts 201 and 202 of the handlebar tube are articulated using an articulation device 210 according to the invention.

In the second embodiment of FIG. 6, the articulation device 210 is such that the articulation device is wholly situated above the head tube 204. Thus the head tube 204 in the conventional way bears the fork column 205 that pivots in the head tube 204 and in which the handlebar tube made up of the two parts 201 and 202 is engaged. This embodiment presents a great advantage in terms of simplicity and compactness.

The articulation device 210 of FIG. 6 is depicted closed and in perspective in FIG. 7. It comprises an upper plate 250 and a lower plate 230 which are articulated so that they can rotate about a shank, the pivot pin, 280.

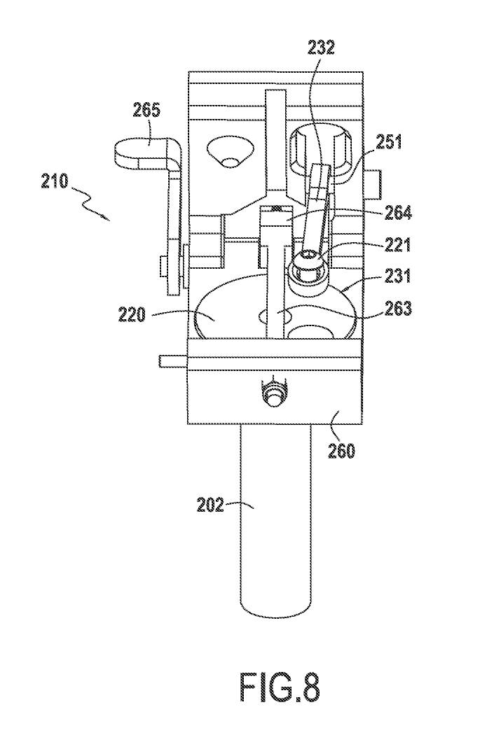

These plates 230 and 250 form a kind of jaw. The opening of this jaw is prevented by a locking element 260. This element is advantageously a hook 260 pivoting about a horizontal pivot pin 266 perpendicular to the steering column and fixed to the lower plate 230. A hooked part 261 of the hook 260 slides along the upper external surface of the upper plate 250 when the two plates 230 and 250 are butted against one another, that is to say when the steering column is unfolded. The sliding movement is advantageously caused by a locking shank 263 associated with a cam 264 providing its forward and backward translational movement. This cam 264 is made to rotate by a lever 265 visible in figure 8 in which the articulation device 210 has been depicted open and head on.

One other possible embodiment is a U-shaped lock of which two branches, similar to the hooked parts 261 and 262 of the hook 260, both slide along the external surfaces of the two plates 230 and 250 butted against one another when the handlebar tube is unfolded.

The locking shank 263 is fixed to the cam 264 and to the hook 260 by screwing or alternatively using rivets. These screw/nut assemblies or rivets leave sufficient clearance to allow pivoting generated by the linear translational movement of the hook and its rotational movement about the pivot pin 266.

The lever 265 is made to turn about the shank 280 backward for unlocking and forward for locking the articulation device 210. The lever 265 therefore, via the cam 264 and the shank 263, returns the hook 260 which then blocks the plates 230 and 250 which are clamped against one another.

Moreover the lower plate 230 also comprises a cylindrical housing 231 intended to accept a rotary swivel 220 that takes the form of a disk. This disk is secured to the bottom part 202 of the handlebar tube and to the fork column 205 and is able to rotate in the housing 231.

In the embodiment depicted in FIG. 8, this rotation in the housing 231 is forced by a link rod 232 attached firstly to the upper plate 250 and to the rotary swivel 220. This link rod 232 is advantageously attached to these two components 220 and 250 with a clearance that will allow an offsetting as depicted in FIG. 8.

In an advantageous embodiment of the invention, the link rod 232 is fixed to a stud 221 perpendicular to the surface of the rotary swivel 220 and to a stud or a shank 251 parallel to the shank 280 that articulates the two plates 230 and 250 to one another.

When the upper plate 250 is separated from the lower plate 230 the link rod 232 then pulls on the stud 221. That then causes the rotary swivel 220 to turn in the housing 231. The wheel 200 is therefore brought to the side through an angle that is predetermined by the angle of rotation of the rotary swivel 220 caused by the separating of the plates 230 and 250.

It will be noted here that the rotary swivel 220 cannot leave its housing 231 from the top because of the head tube and because of the upper headset which butts against the lower plate 230 when the bottom part 202 of the handlebar tube engages in the fork column 205. The rotary swivel 220 is in fact held by a screw screwed into a plunger pushed and clamped deeply inside the tube 202, bottom part of the handlebar tube. This screw clamps the assembly onto the head tube and in the region of the upper headset which itself butts against the lower plate 230 as the bottom part 202 of the handlebar tube is engaged in the fork column 205 which clamps onto the head tube 204.

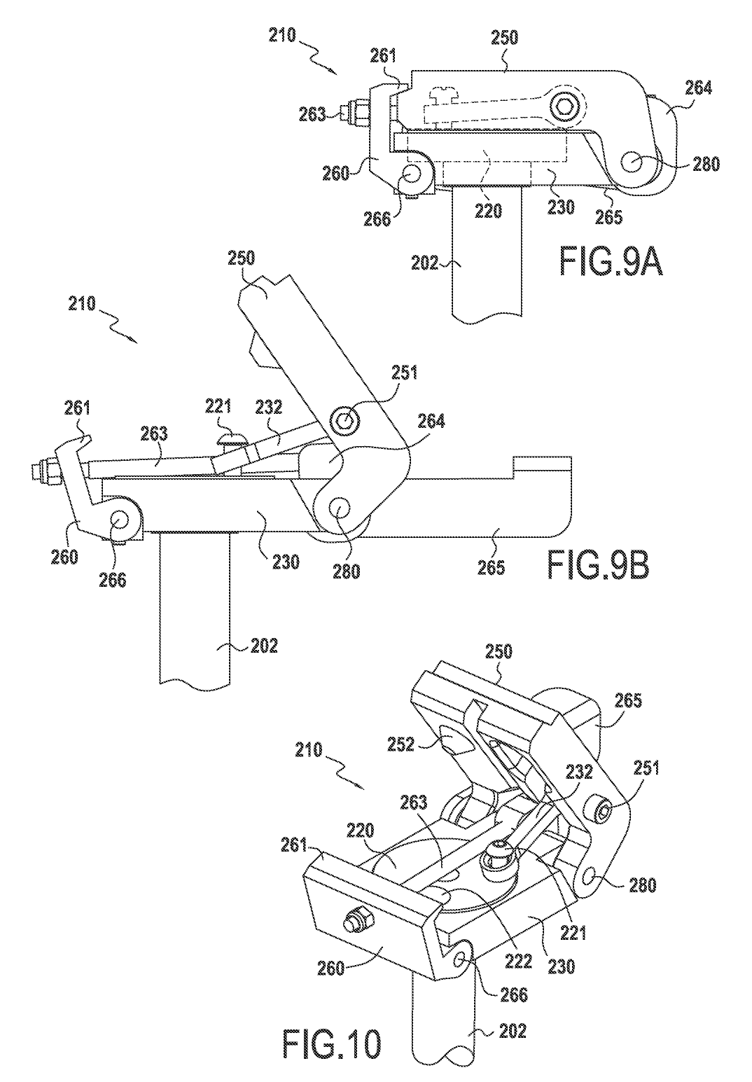

FIGS. 9a and 9b show the articulation device closed and open in a side view. It can be seen that the stud 221 has moved so that the rotary swivel 220 travels an angular path of the order of 90°.

FIG. 10 is a perspective view of the second preferred embodiment of an articulation device according to the invention in an open position. Here it may be seen that there is a relief 252, preferably a conically tapered one, able to slide into an orifice 222 of complementary shape made in the rotary swivel 220 and intended to accept it in the closed up position. This relief 252 and the complementary orifice 222 constitute an element that locks the relative movements of the upper plate 250 and the rotary swivel 220. The fitting of this relief 252 into the orifice 222 prevents any unintentional rotational movement of the rotary swivel 220 with respect to the upper plate 250. Indeed, in view of the torsion loadings transmitted by the fork column, the fitting of this relief reinforces the action of the link rod which by itself would have difficulty in keeping the upper plate 250 and the rotary swivel 220 in a fixed position in relation to one another.

If this rigidity is not provided, the relative rotational movements of the rotary swivel 220 and of the upper plate 250 are particularly detrimental to the user who would be unable to steer and also to the articulation device itself, which would very rapidly deteriorate.

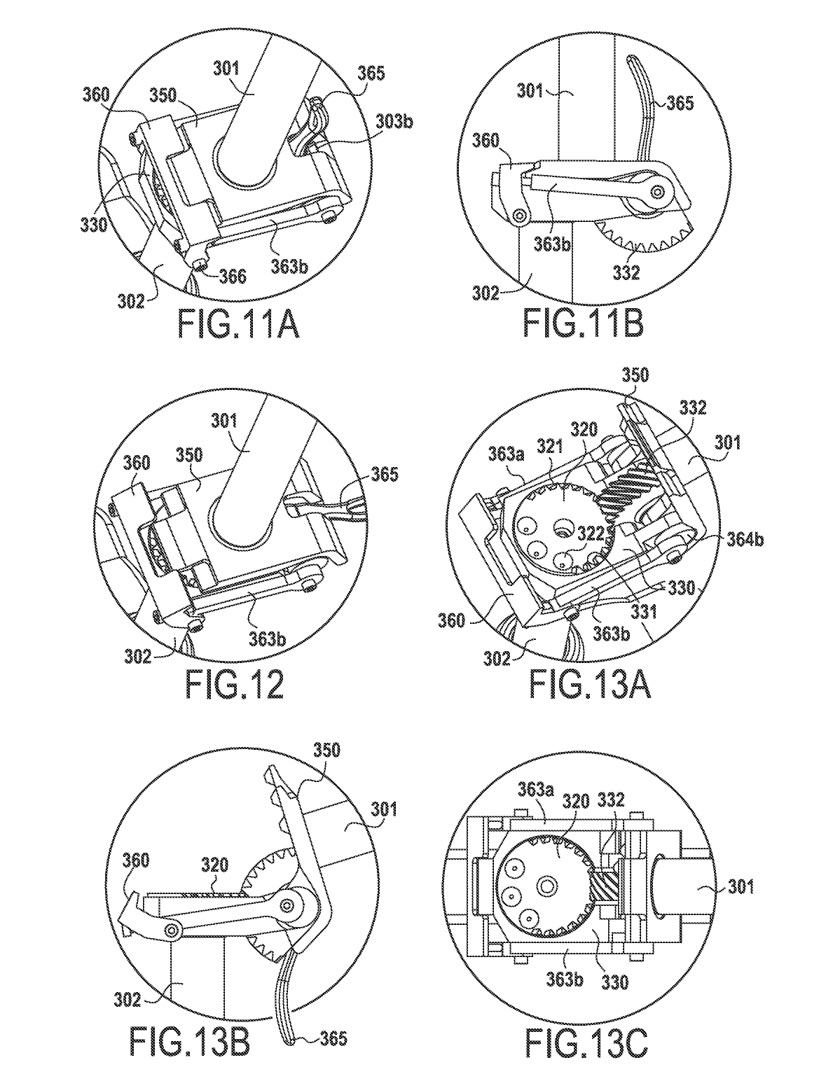

FIGS. 11, 12 and 13 show an alternative form of the second embodiment of an articulation device 310 according to the invention. This alternative form operates on the same principle as the second preferred embodiment by forcing a rotary swivel 320 to rotate as the handlebar tube made in two parts 301 and 302 is folded.

An upper plate 350 here is mounted to rotate about a pivot pin 380 perpendicular to the steering column and not visible in the figures, because it is hidden by a link rod 363b and a cam 364b, with respect to a lower plate 330. This upper plate 350 is secured to a gear portion 332 visible in FIG. 11B which bears a gear structure that complements another circumferential gear structure 321, visible in FIG. 13A, present on the circumference of the rotary swivel 320. Because the two axes of rotation are perpendicular, the gear structures consist of teeth at 45° to the axes of rotation of the two components.

The lower plate 330 is therefore symmetrically mounted for rotation with respect to the upper plate 350 about the horizontal pivot pin 380 and comprises a housing 331 to retain the rotary swivel 320 so that the latter can pivot in its housing 331 when driven by the meshings of the gearwheel portion 332 of the upper plate 350 with which its circumference is in contact.

The three FIGS. 11, 12 and 13 show three stages of operation of the articulation device according to this alternative form. In FIG. 11, the device is closed and locked. Lateral link rods 363a and 363b then pull on a U-shaped hook 360 articulated about a pivot pin 366 and the branches of which slide on each side of the block formed by the upper plate 350 and the lower plate 330.

In FIG. 12, the link rods 363a and 363b are pushed forward by actuating a lever 365 which makes the lateral cams 364a and 364b, preferably mounted so that they can rotate about the pivot pin 380, turn. The lock 360 then frees the two plates 330 and 350 for a rotational movement in relation to one another about the pivot pin 380.

In FIG. 13, the articulation device is shown open and therefore unlocked. This figure provides a clear demonstration of the phenomenon of the meshing at 90°, i.e. at two times 45°, about two perpendicular axes, of the gearwheel portion 332 which is toothed at 45° on its periphery and the toothed peripheral portion 321 of the rotary swivel 320. It must be pointed out here that there is no need for the rotary swivel 320 to be toothed around its entire periphery because the rotary swivel 320 has to be made to rotate only over a portion of a circular arc.

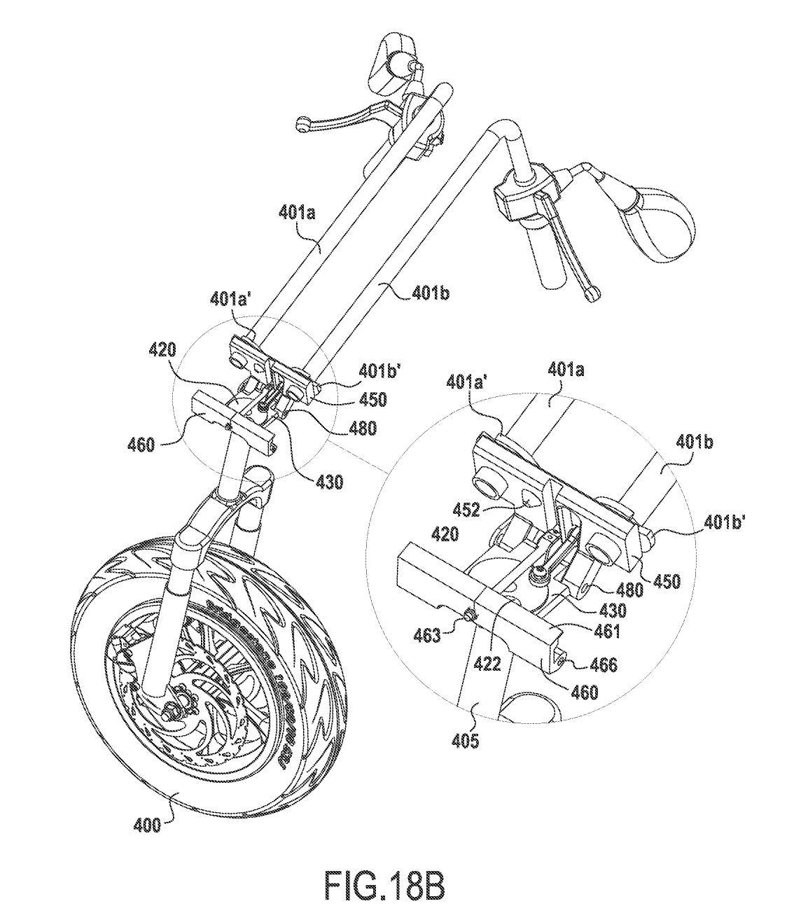

FIGS. 18A and 18B show one particularly advantageous embodiment of an articulation device 410 according to the invention. In FIG. 18A, the articulation device is shown locked with the steering column and the handlebar in the unfolded positions. FIG. 18B shows the device with the steering column folded.

In this embodiment, the three functions of folding over the steering column, of folding the front wheel over at 90°, and of folding the handlebar grips and locking them in position, are performed by the articulation device 410 alone. By comparison with the second preferred embodiment and the alternative form thereof, this articulation device has modifications on its upper plate 450 to accommodate the top part of the handlebar tube which is in the form of two distinct lateral tubes referenced 401a and 401b. It will be noted that the lower plate 430 is similar to that of the other two embodiments.

The articulation device 410 is made in five parts connected by link rods and hinges. It comprises a lower plate 430 attached to an upper plate 450 by a hinge about a horizontal pivot pin 480 perpendicular to the steering column.

The lower part 430 supports a rotary swivel 420 which rests on it in rotation in the horizontal plane and passes through it to be clamped to a fork column 405 via a bottom part of the steering column 402 inserted in the fork column, and to forks supporting a front wheel 400 via a head tube 404, not depicted, provided with headsets that allow said forks to rotate. The clamping of the bottom part 402 bearing the rotary swivel 420 in the fork column 405 and of the forks via the head tube 404 holds the articulation device 410 in position with respect to the chassis.

The upper plate 450 supports two lateral handlebar tubes 401a and 401b which themselves support handlebar grips in their upper part. Advantageously, these handlebar tubes are each inserted in vertical housing formed right through the plate 450 and in which they are free to rotate. Thus, the handlebar tubes 401a and 401b supporting the handlebar grips can pivot horizontally. The handlebar grips can therefore be deployed or folded easily.

The lateral tubes 401a and 401b are therefore mounted to rotate about an axis parallel to the steering column and about their longitudinal axis. Nonetheless, other ways of mounting the lateral tubes to rotate about axes that are perpendicular to their longitudinal direction could be imagined, these tubes then if need be being bent for a first time so that they stand up vertically and then bent over a second time to form the handlebar grips.

As in the second embodiment, the articulation device 410 comprises a locking element in the form of a hook 460. In the embodiment of FIG. 18, the hook 460 comprises a system for impeding the rotational movement of the two lateral tubes 401a and 401b.

In a similar way to the way employed in the preferred embodiment, a lock 460 clamps the plates 450 and 430, which themselves clamp the rotary swivel 420. This hook for example takes the form of a hook that is articulated to a pivot pin 466, installed on the lower plate 430 and parallel to the pivot pin 480 about which the plates 450 and 430 are articulated. The hook 460 slides under stress over the upper plate 450.

A lever 465 allows the lock 460 to be operated, said lock 460 being moved by an attached link rod having an eccentric fix to the lever 464.

Advantageously, the articulation device comprises a system for guiding the rotary swivel 420 using a link rod or a system of gearing.

In a closed position, the plates 450 and 430 clamp the rotary swivel 420 and immobilize it using an appropriate device, in this instance studs and complementary orifices on the rotary swivel 420 and on the upper plate 450.

Clamping in the closed state is provided by the lock 460 operated by the lever 465.

In the unlocked and open position the plates 450 and 430 no longer clamp the rotary swivel 420, no longer preventing it from rotating and therefore allowing the fork to rotate with respect to the chassis of the cycle.

According to the embodiment of FIGS. 18A and 18B, the tubes 401a and 401b are advantageously half-handlebars. At their bottom part they comprise a system for identifying their rotational position. This system may be either a slot in each tube or a fixed collar comprising a cut at the desired location, or a stud embedded so that it projects, etc.

In the particularly advantageous embodiment of FIG. 18, the hook 460 further comprises a shape such that it is able to block the rotation of the lateral tubes 401a and 401b that form the top part of the handlebar tube. The hook of the lock 460 thus advantageously additionally comprises two elements that complement the position identification systems that identify the position of the lateral tubes.

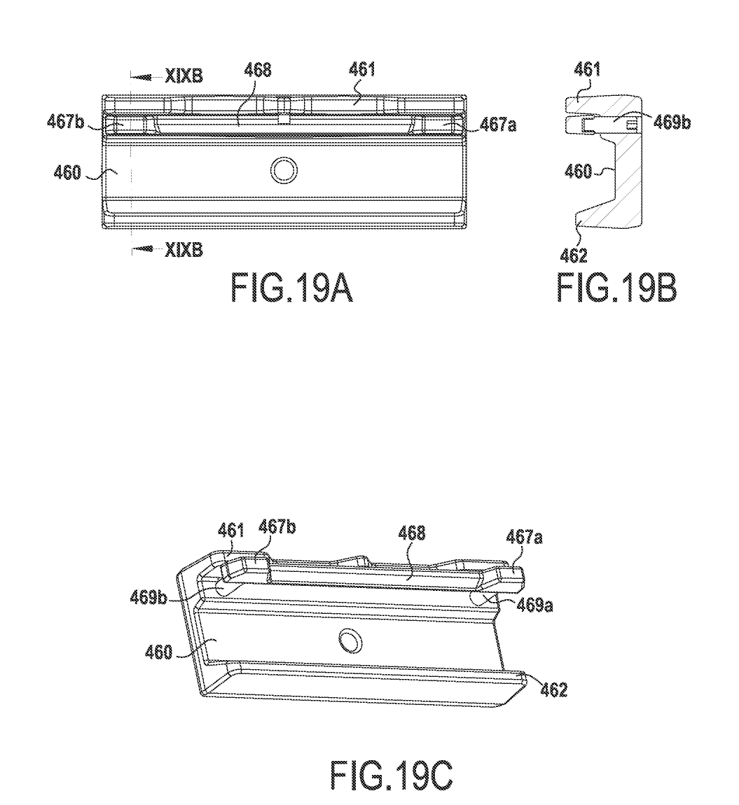

In the embodiment shown, the identification systems consist of a notch in a washer positioned at the bottom of each tube near the upper plate 450. The hook then has protrusions, for example studs 467a and 467b, visible in FIGS. 19A and 19B which depict the lock alone in an advantageous embodiment.

These protrusions are installed laterally on each side and positioned facing the handlebar tube identification systems in the deployed position.

When the lock 460 is operated by the lever, firstly it clamps the plates 430 and 450 firmly against one another, also blocking the rotary swivel 420 in position and secondly it inserts its two studs 467a and 467b in the identifying cuts of the handlebar tubes 401a and 401b in the deployed position, preventing these from rotating. The clamping of the lock 460 thus allows all the components to be held firmly in their intended positions with respect to one another. To do that, as already mentioned, the lateral tubes 401a and 401b bear complementary shapes.

Thus, it has been seen that, when tubes mounted to rotate about their longitudinal direction are used in the way shown in FIG. 18, the tubes advantageously in their bottom part bear disks 401a′ and 401b′ acting as washers and having a circumferential shape that complements a shape borne by the hook 460.

Other embodiments are, however, possible. For example, if the hooked part 461 of the hook 460 is flat without a notch, similar to the hook 260 depicted in FIG. 7, then the washers 401a′ and 401b′ are truncated in such a way as to have a linear segment between two points on their circumference. The hooked part 461 then simply presses against this linear segment when the hook 460 is locked. The use of such a hook 460 comprising a flat part without a notch is also possible when the lateral tubes are mounted to rotate about an axis perpendicular to their longitudinal direction.

However, this embodiment with a flat unnotched hook part 461 is such that the application of stress to the handlebar halves has a tendency to push against the hooked part 461 to disengage it from the plates 450 and 430, thus tending to unlock the articulation device. That may prove to be detrimental from a safety standpoint.

Thus, the preferred embodiment is such that the hooked part 461 has stud-like shapes 467a and 467b in a plane parallel to the surface of the upper plate 450. These studs 467a and 467b have complementary shapes in the form of orifices or notches made in the washer disks 401a′ and 401b′ or directly in the lateral tubes 401a and 401b, as may be seen in FIGS. 18A and 18B.

When the articulation device is locked, the studs 467a and 467b become housed in the orifices provided for this purpose in the washers 401a′ and 401b′ or in the lateral tubes if, for example, these have a slot. Rotational movement of the lateral tubes 401a and 401b is then prevented.

With this embodiment, handling operations are simplified because all the locking/unlocking operations are performed by a single lock and a single action on the lever, therefore in a single movement. Further, the embodiment is more economical because this configuration relies on a simple increase in the dimensions of the upper plate 450 to support the two branches of the handlebar 401a and 401b, and the lock 460 to support two studs 467a and 467b facing the position references for the handlebar tubes 401a and 401b, by comparison with a configuration in which the functions of folding over the handlebar grips are separate from those of folding over the handlebar and the wheel. That avoids the need to produce a special component for the folding/unfolding of the handlebar grips according to the prior art. Installation on a vehicle is also simpler because there is just one component to be installed which performs all the functions.

Nonetheless, it will be noted that because the single locking component 460 performs the joint locking of the plates 430, 450, of the rotary swivel 420 by clamping, and of the two vertical tubes of the handlebar by obstruction, it is beneficial for a system of adjustment for each of these actions to supplement the device. That in particular avoids the inevitable play between the various components leading to unwanted unlocking of the articulation device.

Thus, as depicted in FIG. 19, the studs 467a and 467b that impede the rotation of the handlebar tubes 401a and 401b are then advantageously mounted on a component 468 which is itself attached to the lock 460 by screws 469a and 469b that allow its separation from the lock 460 to be adjusted, thus fine-tuning the extent to which the studs 467a and 467b penetrate the housings in the bottom of the handlebar tubes 401a and 401b.

The apposition of the lock 460 in clamping the parts 430 and 450 is also adjusted, as in the previous embodiments, using a nut at the end of the link rod that operates it.

FIG. 14 is a cross section of the top of a folding and folded handlebar 140 or 240 like the one used in another implementation of the invention on the top part of a steering column of a cycle 10 or 20 that does not implement the particularly advantageous embodiment of FIG. 18. It will be noted here that the use of the handlebar depicted in this figure and the following figures can be used in combination with or independently of the use of an articulation device for articulating the fork column according to the invention. However, the additional use of such a handlebar on a cycle that has a device according to the invention is particularly advantageous because it adds further to the compactness, once folded, of the elements needed for steering the cycle which are the front forks and the handlebar.

The handlebar referenced 140 hereinafter is fixed to the top part of said steering column 101. It comprises a casing 141 at the ends of which are mounted two rotation shanks 142a and 142b about which the two lateral half-handlebars 143a and 143b are articulated.

The half-handlebars 143a and 143b are made to leave the casing 141 as they rotate by cutouts 144a, 144b and 145a, 145b in the front and rear of the handlebar respectively when considering the normal direction in which the cycle is ridden.

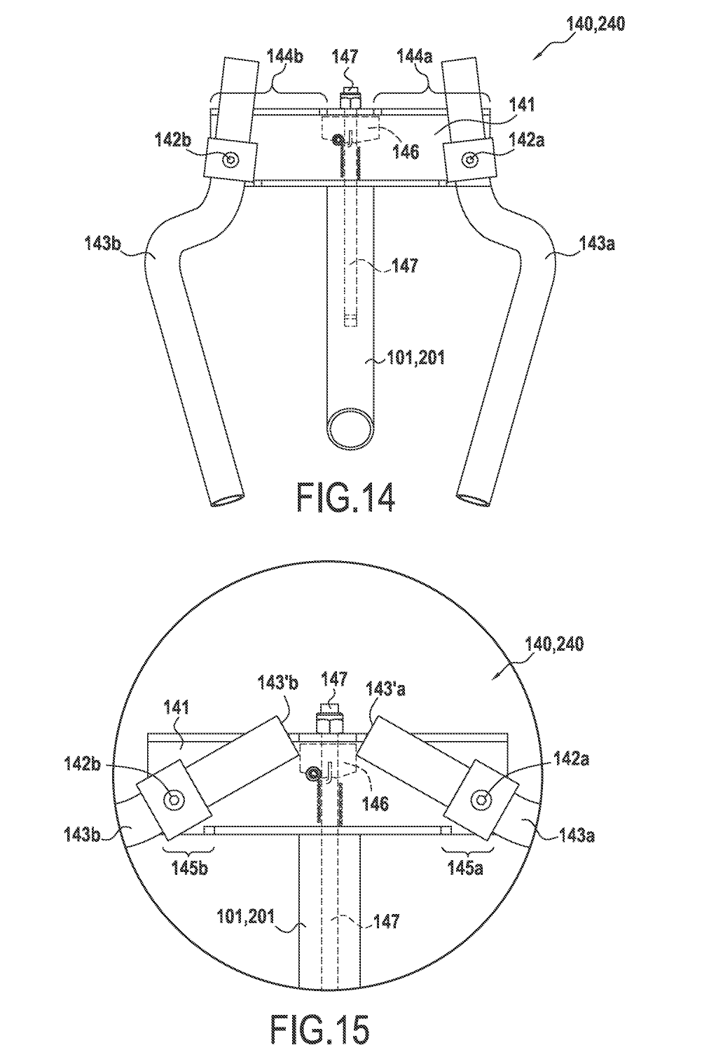

FIG. 15 illustrates the movement of the lateral half-handlebars 143a and 143b as the handlebars are unfolded. The internal ends 143a′ and 143b′ of the half-handlebars then butt against a double pawl 146 mounted to rotate by virtue of a pivot pin 147 that is mounted to rotate with respect to the casing 141.

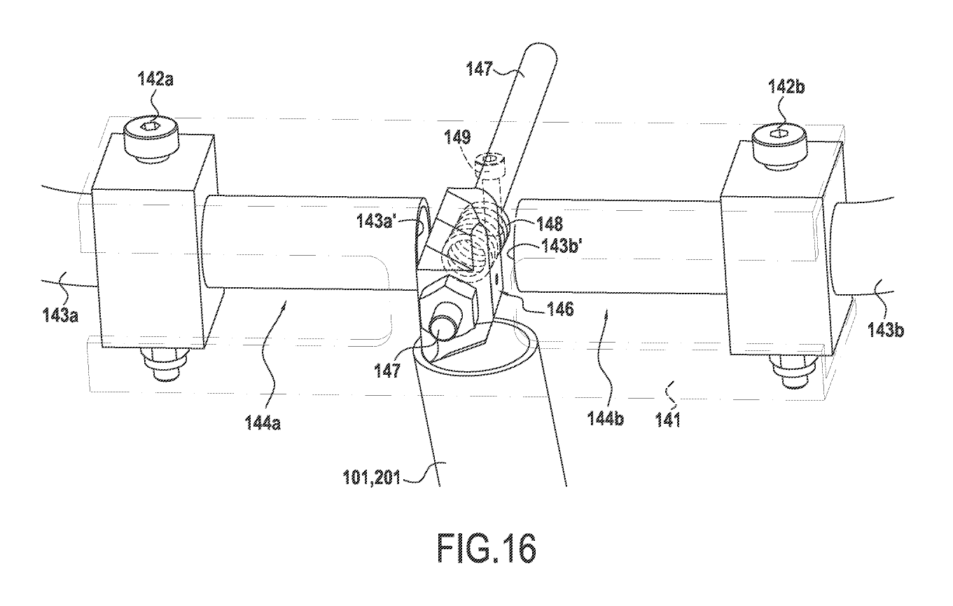

FIG. 16 is a perspective view of a detail of the handlebar 140 as it is being unfolded.

As the handlebar is being unfolded, the ends 143a′ and 143b′ butt against the pawl 146 and cause the pawl 146 to turn. This rotational movement is brought about thanks to beveled surfaces, visible in FIG. 16, that the pawl 146 comprises symmetrically about the central axis 147. These surfaces are such that contact from the ends of the half-handlebars 143a and 143b causes them to slide along the beveled surfaces while at the same time causing the rotational movement of the pawl 146.

The pawl 146 is associated with a spring 148 which forces it to return to the position depicted in FIG. 15 once the ends of the half-handlebars 143a and 143b have passed beyond the beveled surfaces. This return is halted by a limit stop 149, which in this instance is a screw, against which the pawl 146 butts. The half-handlebars 143a and 143b are therefore blocked in unfolded positions by the rear surface of the pawl 146.

The pivot pin 147 fixedly mounted with the pawl 146 is extended in a way accessible to the motorcyclist, advantageously toward the rear of the cycle, to allow him to deactivate the locking of the ends 143a′ and 143b′ of the half-handlebars 143a and 143b between the pawl 146 and the rear of the casing 141.

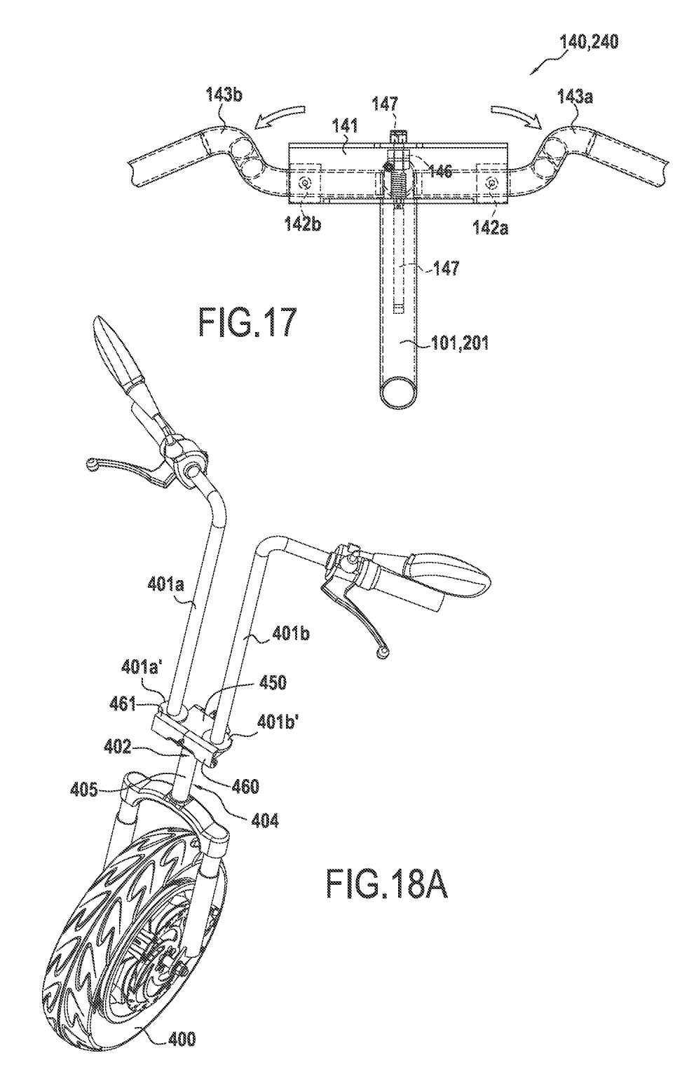

That is illustrated in FIG. 17 which is a cross section of the top of the handlebar according to the invention. The pawl 146 is at 90° from its rest position in which the half-handlebars are blocked in the unfolded position. This manual rotating of the pawl 146 is carried out using the extended pivot pin 147. The half-handlebars then become free to turn, the rotation being depicted schematically by arrows.

In the first embodiment shown, it is conceivable for the unlocking of the handlebar to be coupled in such a way that the handlebar can be folded with the unlocking of the articulation device according to the invention. This is advantageously achieved using a cable stretched between the lever handle 164 and the pivot pin to which the pawl 146 is attached. Handling operations are thus reduced by using the same lever to lock/unlock the position of the steering column and the handlebar halves.

Finally, it will be noted that the invention may be embodied in the various ways listed in the claims that follow.

In particular, it will be pointed out that the invention also relates to any embodiment comprising two plates of the type 122 and 123 between which there is offset a steering column offset from the fork column proper and comprising elements that perform the same functions as those explained in the preferred embodiment, that is to say they allow the bottom part of the handlebar tube to pivot through a determined angle at the same time as the top part of the handlebar tube is being pivoted backward. It is also possible according to the invention to produce an articulation device of the type of the first embodiment which at the top has two lateral parts as described for the second preferred embodiment. Rotation of the two lateral parts is then impeded by any suitable means which may or may not be in combination with the locking elements that exist in the first embodiment.

1. An articulation device for articulating a so-called steering column of a cycle comprising a chassis, said steering column being made up of at least one fork column and a handlebar tube, this steering column comprising two parts, a first part known as the top part supporting the handlebar of the cycle and a second part known as the bottom part supporting at least one front wheel, the articulation device allowing the steering column to be folded and being intended to be positioned above the head tube of the cycle, characterized in that said articulation device which can be installed on a cycle that has a fairing, allows the steering column to be folded along the chassis of the cycle, the two parts of the steering column being articulated to one another to rotate about an axis perpendicular to the direction of the head tube and to rotate about an axis parallel to the head tube, so as to allow the bottom part of the steering column to be folded over about the axis parallel to the head tube at the same time as the top part is being folded along the chassis of the cycle, and in that the articulation device further comprises locking elements that lock the articulation to prevent both types of rotation.

2. The device as claimed in claim 1, characterized in that once the locking elements have been deactivated, the rotational articulations are such that the bottom part of the steering column is free to rotate in the head tube.

3. The device as claimed in claim 1, characterized in that once the locking elements have been deactivated, the rotational articulations are such that the bottom part of the steering column is forced to rotate over a portion of predetermined angle when the top part of the steering column pivots about the axis perpendicular to the steering column.

4. The device as claimed in claim 1, characterized in that, with the articulation device being intended to be installed on the handlebar tube, it comprises two plates articulated about a pivot pin perpendicular to the steering column, an upper plate being secured to the top part, the lower plate being such that the bottom part of the steering column is mounted to rotate with respect to this lower plate, the locking elements being capable of keeping the plates folded over on one another, thus preventing the top part from rotating about an axis perpendicular to the steering column and also preventing the bottom part from rotating about the axis parallel to the steering column.

5. The device as claimed in claim 4, characterized in that the locking elements comprise a hook pivoting about a horizontal pivot pin perpendicular to the steering column, fixed to the lower plate, and of which a hooked part slides along the upper external surface of the upper plate when the two plates are butted against one another when the steering column is unfolded.

6. The device as claimed in claim 4, characterized in that the locking elements comprise a U-shaped lock the two branches of which slide along the external surfaces of the two plates butted against one another when the steering column is unfolded.

7. The device as claimed in claim 5, characterized in that the sliding movement of the hooked part is brought about by a lever associated with a cam.

8. The device as claimed in claim 4, characterized in that the bottom part of said steering column comprises a rotary swivel passing through the lower plate in which it is mounted such that it can rotate.

9. The device as claimed in claim 8, characterized in that the rotary swivel comprises locking elements in relief that complementary reliefs made on the upper plate, these reliefs interlocking when the two plates are folded over against one another.

10. The device as claimed in claim 8, characterized in that the rotary swivel comprises at least one traction point that can be connected by a link rod to a traction point on the upper plate, this traction point driving the rotary swivel in rotation as soon as the plates become separated from one another during the folding of the top part of the steering column onto the chassis of the cycle.

11. The device as claimed in claim 10, characterized in that the link rod is fixed with play on a pintle that has a retaining head positioned perpendicular to the upper surface of the rotary swivel and clamps a shank of axis parallel to the axis of rotation of the two plates.

12. The device as claimed in claim 4, characterized in that the upper plate carries gear structures that complement gear structures carried by the rotary swivel meshing at 90° to one another and driving the rotary swivel in rotation as soon as the plates are separated from one another as the top part of the steering column is folded onto the chassis of the cycle.

13. The device as claimed in claim 4, characterized in that the top part of the steering column is made up of two symmetric lateral tubes each connected to half a handlebar, these lateral tubes being mounted to rotate with respect to the upper plate about axes that are substantially parallel to the steering column so that the half-handlebars can be folded over toward one another as the steering column is folded, the rotations of the two lateral tubes being impeded when the locking elements are activated.

14. The device as claimed in claim 13, characterized in that the hooked part of the hook has a shape that allows it to impede the rotational movement of the two lateral tubes which have shapes that complement the shape of the hooked part.

15. The device as claimed in claim 14, characterized in that the lateral tubes each comprise a washer disk the shape of which cooperates with the shape of the hooked part to prevent the rotation of the lateral tubes.

16. The device as claimed in claim 14, characterized in that the complementary shapes are chosen from two flat surfaces or a stud with complementary housing.

17. The device as claimed in claim 16, characterized in that, when the complementary shapes are a stud collaborating with a complementary housing, the studs are mounted on a component that is itself attached to the hook by screws that allow its separation from the hook to be adjusted, thus fine-tuning the extent to which the studs penetrate the housings in the bottom of the handlebar tubes.

18. The device as claimed in claim 1, characterized in that the device comprises two bearers known as the top bearer and the bottom bearer, the top part supporting the handlebar tube and the bottom part supporting the fork column, and a part known as an intermediate part mounted to rotate about an axis perpendicular to the direction of the head tube with respect to one of the bearers, thus allowing this bearer to rotate about an axis perpendicular to the direction of the head tube and to rotate about an axis parallel to the head tube with respect to the other bearer and thus allowing the other bearer to rotate about an axis parallel to the steering column.

19. The device as claimed in claim 18, characterized in that the bottom part of the steering column has a complex structure made up of a fork column which is offset toward the rear of the cycle with respect to the handlebar tube and can be housed in the head tube secured to the chassis of the cycle and two lateral arms extending the forks and between which the handlebar tube is positioned, these two lateral arms being positioned between two plates that also hold the offset fork column.

20. The device as claimed in claim 18, characterized in that the intermediate component comprises a shank positioned perpendicular to the direction of the head tube and around which the top bearer is mounted to rotate, this shank bearing, at its ends, structures that are capable of pivoting or sliding in complementary structures borne by the bottom bearer during a rotational movement of the intermediate component with respect to the top bearer about an axis parallel to the direction of the head tube.

21. The device as claimed in claim 20, characterized in that the structures borne by the intermediate shank are, respectively, a lug of axis parallel to the shank and a lug of axis perpendicular to the shank to slide respectively in a translational movement in an arc-shaped slideway borne by the bottom bearer and in a rotational movement in an orifice made in the bottom bearer.

22. The device as claimed in claim 20, characterized in that the locking elements comprise a lug able to slide along the handlebar tube and become housed in an orifice provided for this purpose in the bottom bearer.

23. The device as claimed in claim 22, characterized in that the sliding movement of the lug is commanded by a lever handle associated with a link rod.

24. The device as claimed in claim 1, characterized in that the top part of the steering column bears a folding handlebar comprising two lateral half-handlebars tubes bearing handlebar grips which tubes are mounted to rotate about two pivot pins at the two ends of a central casing comprising notches to allow this rotation of the lateral tubes and a retaining element for holding the half-handlebars in position, the two pivot pins about which the two lateral half-handlebars are mounted to rotate make an angle of between 10° and 40° downward and toward the rear of the cycle, with respect to the vertical.

25. The device as claimed in claim 24, characterized in that the casing comprises a double pawl positioned at the center of this casing and mounted for partial rotation with a return spring, about a shank perpendicular to the longitudinal direction of the casing, the pawl having a surface known as the rear surface that is such that, depending on the angle made by the pawl with respect to the longitudinal direction of the casing, it either allows or does not allow the tubes to pass, and a front surface of beveled shape the bevel being symmetric with respect to the pivot pin, so that the tubes come against the beveled surfaces as the handlebar is unfolded, causing partial rotation of the pawl, this rotation freeing the movement of the tubes which position themselves behind the pawl, this pawl then, thanks to the return spring, repositioning itself in front of the tubes thereby preventing their rotational movement by contact of the tubes on its rear surface, the pawl being connected to an unlock knob mounted on the pivot pin of the pawl and allowing the rotational movement of the tubes to be freed through the turning of this knob.
